(19) United States
(12) Patent Application Publication
(10) Pub. No.: US 2004/0042376 A1
(43) Pub. Date: Mar. 4, 2004

(54) Information recording method

(75) Inventor: Andrew C. Chang, Hsin-Chu City (TW)

Correspondence Address: TROXELL LAW OFFICE PLLC, 5205 LEESBURG PIKE, SUITE 1404, FALLS CHURCH, VA, 22041, US

(73) Assignee: MediaTek Inc.

(21) Appl. No.: 10/610,655

(22) Filed: Jul. 2, 2003

(30) Foreign Application Priority Data
Sep. 2, 2002 (TW) 091119918

(51) Int. Cl. G11B 7/135

(52) U.S. Cl. 369/111; 369/112.24

(57) ABSTRACT

This invention provides an information recording method to record a digital information file onto an information recording medium. The digital information file comprises a plurality of digital data. The information recording medium comprises a plurality of predetermined recording units which are arranged sequentially on the information recording medium from a inner area to an outer area in order to record the plurality of digital data in the digital information file. The outer area of the information recording medium has a recording start unit, the information recording method starts recording from the recording start unit to sequentially record the plurality of digital data in the digital information file on the information recording medium from outer to inner.

### BACKGROUND OF THE INVENTION

1. Field of the Invention

The present invention relates to an information recording method. And more particularly, the present invention indicates an information recording method to record digital information file onto an information recording medium.

2. Description of the Prior Art

A CD drive is a conventional information recording device, used to record a digital information file onto an information recording medium, such as a compact disk (CD). For example, the most inner circle of the circle shaped CD in the prior art comprises an Information Area. The Information Area comprises a Power Calibration Area (PCA), a Program Memory Area (PMA), and at least a session. The PCA is provided for the CD drive to decide correct powers when reading or recording the CD. The PMA is located between the PCA and the session, comprising the information about the start time and the stop time of all tracks in the CD. The session is located after the PMA, recording the content of the digital information file. Each session comprises a Lead-in Area and a Lead-out Area. The session further comprises a recording start unit after the Lead-in Area.

In the prior art, when recording digital information on a CD, a CD drive rotates the CD in a rotating speed, and starts recording the digital information file from the recording start unit, sequentially from the inner circles of the CD to the out circles before the Lead-out Area.

When later another CD drive wants to correctly read the digital information file, it can just read the PCA and the PMA first to correctly read the digital information file recorded in the sessions.

Because the rotating speed of the CD is constant, the writing speed in which the CD drive writes digital data on the outer area in the CD is faster than the writing speed in which the CD drive writes digital data on inner area in the CD.

For a CD, the longest radius is 3 times longer than the shortest one. The speed in which a CD drive records or reads the most outer circle of the CD is about 3 times more than the speed in which a CD drive records or reads the most inner circle of the CD.

Since the conventional way that CD drive records CD is to start from the start recording units, and move from the inner part to the outer part. That is, start from a slower writing speed, and waste a lot of recording time. The present invention is primarily to provide an information recording method to accelerate the speed in which CD drive record digital data on the CD.

### SUMMARY OF THE INVENTION

The present invention relates to an information recording method. And more particularly, the present invention indicates an information recording method to record digital information file onto an information recording medium.

This invention provides an information recording method to write a digital information file onto an information recording medium. The digital information file comprises a plurality of digital data. The information recording medium comprises a plurality of predetermined recording units arranged sequentially on the information recording medium from an inner area to an outer area, in order to record the plurality of digital data in the digital information file. The information recording medium further comprises an inner area and an outer area. The outer area has a recording start unit. The information recording method starts recording from the recording start unit to sequentially write the plurality of digital data in the digital information file on the information recording medium from outer to inner.

According to the invention, the information recording method starts recording from the recording start unit in the outer area sequentially toward the inner area. This can effectively accelerate the writing speed in which a CD drive writes digital data on a CD and further substantially accelerate the recording speed of a CD drive.

The advantages and spirits of the invention may be understood by the following recitations together with the appended drawings.

### BRIEF DESCRIPTION OF THE APPENDED DRAWINGS

FIG. 1 is schematic diagram of a CD utilized in the information recording method of this invention.

FIG. 2 is a schematic diagram of a CD drive according to an embodiment of the present invention.

FIG. 3 shows a CD to explain the difference between the method of this invention and the prior art.

### DETAILED DESCRIPTION OF THE INVENTION

This invention provides an information recording method to record a digital information file onto an information recording medium. The digital information file comprises a plurality of digital data. The information recording method of this invention uses an information recording device to record the digital information file on the information recording medium. The information recording device comprises a writing/reading control software, which controls the information recording device to record or read the digital data. The information recording medium can be an optical disc, such as a CD, a DVD or a HD-DVD. The information recording device can be an optical disc drive. The following is an embodiment with CD.

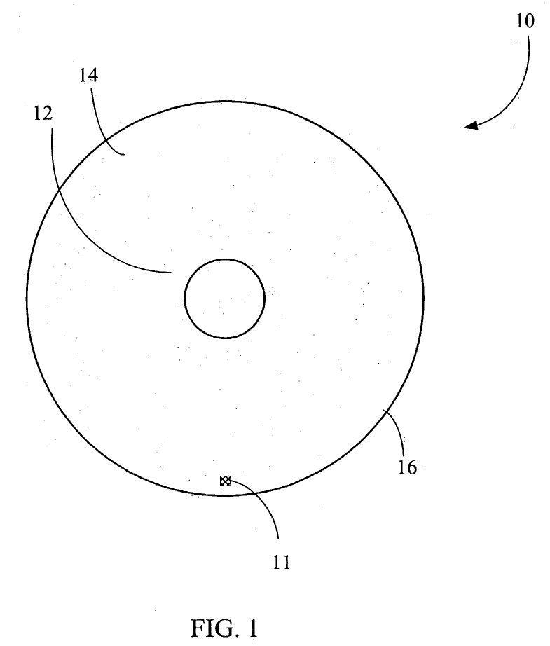

Referring to FIG. 1, FIG. 1 is schematic diagram of a CD 10 utilized in the information recording method of this invention. The CD 10 is circle shaped, comprising a plurality of circle recording pre-grooves (not shown in FIG. 1) arranged in helical way on the CD10. A plurality of recording units is arranged in the circle recording pre-grooves to record the digital data. In this present invention, the recording pre-grooves of information recording medium can be also arranged concentric. The recording units are arranged in the concentric recording pre-grooves to record digital data.

The CD 10 comprises an inner area 12 to an outer area 14. The CD 10 comprises a plurality of predetermined recording units (not shown in FIG. 1) arranged sequentially on the helical recording grooves from an inner area 12 to an outer area 14 in order to record the plurality of digital data in the digital information file.

The outer area 14 has a recording start unit 11. There is an Information Area 16 located in the recording unit outside the recording start unit 11. The Information Area pre-stored a Power Calibration Area (PCA) and a Program Memory Area (PMA) so that the CD drive can read the PCA and the PMA later to correctly read the digital information file.

The information recording method of the present invention starts recording from the recording start unit 11 to sequentially record the plurality of digital data in the digital information file onto the information recording medium from outer to inner.

In order to let this invention can be implement smoothly, outside the recording start unit 11 in the outer area 14 of the CD 10, the Information area 16 has to be set up first. The Information area 16 stores a PCA, and a PMA. When recording the digital information file, the CD drive starts recording from the recording start unit 11 toward inner. After reading the PCA and the PMA, other later information recording devices can correctly read stored digital information file from outer to inner.

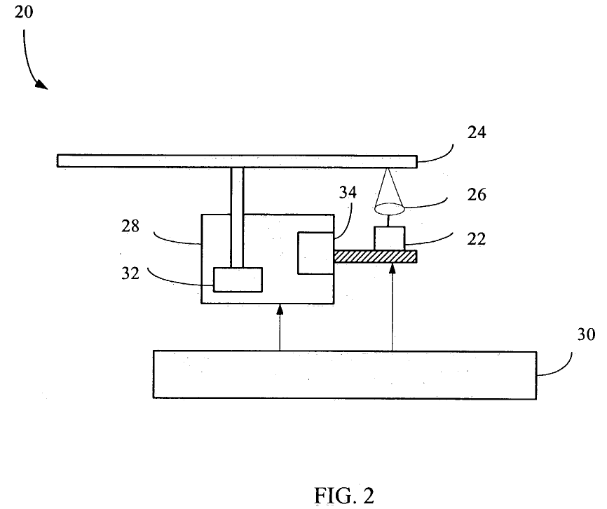

Please refer to FIG. 2. FIG. 2 is a schematic diagram of a CD drive 20 according to an embodiment of the present invention. The CD drive 20 comprises a pickup head 22, a set of optical lenses 26, an actuator 28 and a controller 30. The pickup head 22 emits a light beam, writes the digital data onto the CD 24, and reads the digital data from the CD 24. The set of optical lenses 26 focuses the light beam emitted from the pickup head 22 to the CD 24, and focuses the light beam reflected from the CD 24 to the pickup head 22. The pickup head 22 will receive the reflected light beam so as to facilitate the reading later. The controller 30 controls the pickup head 22, the optical lenses 26 and the actuator 28.

The actuator 28 actuates the pickup head 22, the set of optical lenses 26 and the CD 24 to write or read digital data. The actuator 28 comprises a spindle motor module 32 and a sled motor 34. The spindle motor module 32 rotates the CD 24 in a rotating speed to let the pickup head 22 write digital data on the CD 24. The sled motor 34 controls the pickup head 22 to write digital data from the recording start unit 11 of the outer area 14 to inner.

A writing/reading control software of CD drive 20 controls the sled motor 34 to let the sled motor 34 control the pickup head 22. The sled motor 34 moves from the outer area 14 to inner and lets the pickup head 22 start from the recording start unit 11 in the outer area toward inner to write digital data or read the digital information file. The writing speed in which the pickup head 22 writes digital data on the outer area 14 in the CD 24 is faster than the writing speed in which the pickup head 22 writes digital data on the inner area 12.

The controller 30 will convert the digital data into corresponding writing control commands, and transmit the writing control commands to the pickup head 22 in a data transmitting speed so as to write the writing control commands on the rotating CD 24. The writing speed in which the pickup head 22 writes digital data on the CD 24 is affected by the data transmitting speed of the controller 30 and the rotating speed of the spindle motor module 32. The data transmitting speed is higher than the rotating speed, and the writing speed is confined by the rotating speed.

The rotating speed of the spindle motor module 32 is a constant value. As the pickup head 22 rotates to the outer circle of the CD 24, the rotating radius will increase. When the radius increase as the rotating angle remains the same, the recording unit increases with moving outer. The controller 30 can increase its data transmitting speed as the recording unit increases to make the data transmitting speed higher than the rotating speed. Therefore the writing speed is confined by the rotating speed.

The writing speed in which the pickup head 22 writes digital data on the outer area in the CD 24 is higher than the writing speed in which the pickup head 22 writes digital data on the inner area in the CD 24. Considering that the radius of the most outer radius is 3 times more than the most inner radius, the speed in which the CD drive 20 records/reads the most outer circle of the CD 24 is 3 times more than the speed in which the CD drive 20 records/reads the most inner circle of CD 24.

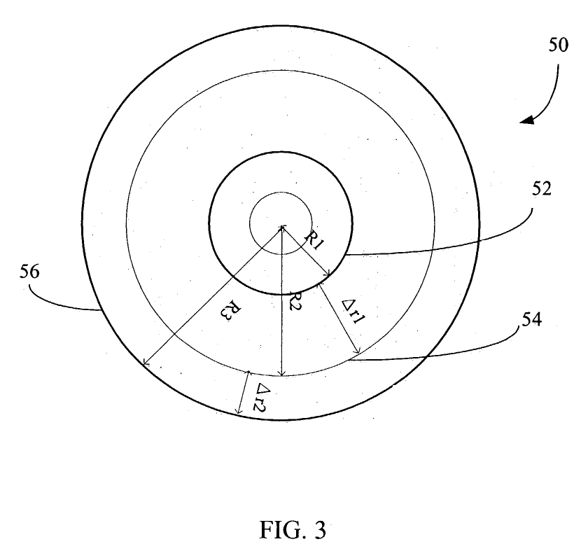

Please refer to FIG. 3. FIG. 3 shows a CD 50 to explain the difference between the method of this invention and the prior art. An instance using a known CD 50 to record an digital information file of 325 MB is introduced to explain how the invention accelerate the recording speed of the CD drive 20. The capacity of the CD 50 is 650 MB and a digital information file desired is 325 MB that is a half of the capacity of CD 50.

Conventionally, it is necessary to start recording from the most inner circle 52 of the CD 50 to the middle part 54 of the CD 50. The most inner circle 52 has a radius R1 of 2 centimeter. The middle part 54 has a radius R2 of 4.472 centimeter. The difference (Δr1) between the radius R1 and the radius R2 is 2.742 centimeter.

This invention directly starts from the start recording unit 11 on the most outer circle 56 of the CD 50, writing the digital information file on the CD 50 from outer circles to inner circles. In order to record the digital information file on the CD 50 intactly, it is necessary to write to the middle part 54 of the CD 50, where with a radius R2 4.472 centimeter. The most outer circle 56 has a radius R3 of 6 centimeter. The difference (Δr2) between the radius R2 and the radius R3 is 1.528 centimeter. Compared with the prior art, the Δr1 of the prior art is 1.618 times of the Δr2 of this invention. Since the rotating speed of pickup head 22 is constant, the time that a CD drive records the information file is: correlated to the difference of the radiuses. That is, the time that the prior art records the same information file is 1.618 times more than the time that this invention needs. Therefore, using this invention can accelerate substantially the recording speed of a CD drive.

In contrast to the conventional method which starts recording from the most inner circle of an information recording medium, the information recording method of this invention starts from the recording start unit in the outer area of a CD, recording digital information file sequentially on the CD from outer to inner.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An information recording method to record a digital information file onto an information recording medium, said digital information file comprising a plurality of digital data, said information recording medium comprising a plurality of predetermined recording units which are arranged sequentially on said information recording medium from an inner area to an outer area in order to record the plurality of digital data in the digital information file; said outer area of the information recording medium having a recording start unit, said information recording method starting recording from said recording start unit to sequentially record the plurality of digital data in said digital information file on said information recording medium from outer to inner.

2. The information recording method of claim 1, wherein said recording units are arranged on a plurality of circle shaped recording pre-grooves to record said digital data.

3. The information recording method of claim 2, wherein said circle recording pre-grooves are arranged in concentric way.

4. The information recording method of claim 1, wherein said recording units are arranged on a helical recording pre-grooves to record said digital data.

5. The information recording method of claim 1, wherein said information recording method uses an information recording device to record said digital information file on said information recording medium, said information recording device comprising a writing/reading control software, which controls said information recording device to write or read said digital data.

6. The information recording method of claim 5, wherein said information recording medium is a compact disc (CD) and said information recording device is a compact disc (CD) drive.

7. The information recording method of claim 6, wherein there is an information Area outside of said recording start unit in said compact disc (CD) and said Information Area pre-stored a Power Calibration Area (PCA), and a Program Memory Area (PMA), so that the CD drive can read the PCA and the PMA later to correctly read the digital information file.

8. The information recording method of claim 7, wherein said CD drive comprises
A pickup head, used to emit a light beam and write said digital data onto said CD, and read said digital data from said CD;
A set of optical lenses, used to focus the light beam emitted from said pickup head to said CD, and to focus the light beam reflected from said CD to said pickup head, said pickup head will receive the reflected light beam so as to facilitate later determination;
An actuator, used to actuate said pickup head, said set of optical lenses and said CD to write or read said digital data; and
A controller, used to control said pickup head, said set of optical lenses and said actuator; and
wherein said actuator comprising a sled motor to control said pickup head to move from the outer area of said CD to the inner area for writing or reading said digital information file.

9. The information recording method of claim 8, wherein said sled motor is controlled by said writing/reading control software, in order that said sled motor start moving from said outer area to inner area to write or read said digital information file.

10. The information recording method of claim 9, wherein said actuator comprises a spindle motor module to rotate said CD in a rotating speed, to let said pickup head write said digital data on said CD, and the writing speed in which said pickup head writes digital data on outer area in said CD is higher than the writing speed in which said pickup head writes digital data on inner area in said CD.

11. The information recording method of claim 10, wherein said controller will convert said digital data into corresponding writing control commands, and transmit said writing control commands to said pickup head in a data transmitting speed so as to write said writing control commands on the rotating CD.

12. The information recording method of claim 11, wherein the writing speed in which said pickup head write said writing control commands on said CD is affected by said data transmitting speed and said rotating speed of said spindle motor.

13. The information recording method of claim 12, wherein said data transmitting speed is higher than said rotating speed, and said writing speed is confined by said rotating speed.

14. An information recording device to record a digital information file onto an information recording medium, said digital information file comprising a plurality of digital data, said information recording medium comprising a plurality of predetermined recording units which are arranged sequentially on said information recording medium from an inner area to an outer area in order to record the plurality of digital data in the digital information file; said outer area of the information recording medium having a recording start unit, said information recording device starting recording from said recording start unit to sequentially record the plurality of digital data in said digital information file on said information recording medium from outer to inner.

15. The information recording device of claim 14, wherein said recording units are arranged on a plurality of circle shaped recording pre-grooves to record said digital data.

16. The information recording device of claim 15, wherein said circle recording pre-grooves are arranged in concentric way.

17. The information recording device of claim 14, wherein said recording units are arranged on a helical recording pre-grooves to record said digital data.

18. An optical recording device to record a digital information file onto an optical recording medium, said digital information file comprising a plurality of digital data, said optical recording medium comprising a plurality of predetermined recording units which are arranged sequentially on said optical recording medium from an inner area to an outer area in order to record the plurality of digital data in the digital information file; said outer area of said optical recording medium having a recording start unit, said optical recording device starting recording from said recording start unit to sequentially record the plurality of digital data in said digital information file on said optical recording medium from outer to inner.

19. The optical recording device of claim 18, wherein optical recording device is an optical disc drive and said optical recording medium is an optical disc.
